(19) United States
(12) Patent Application Publication
(10) Pub. No.: US 2025/0023079 A1
(43) Pub. Date: Jan. 16, 2025

(54) POROUS SOLID OXIDE COMPOSITE AND SOLID OXIDE CELL COMPRISING THE SAME

(71) Applicant: SAMSUNG ELECTRO-MECHANICS CO., LTD., Suwon-si, Gyeonggi-do (KR)

(72) Inventors: Jaeseok Yi, Suwon-si, Gyeonggi-do (KR); Jungdeok Park, Suwon-si, Gyeonggi-do (KR); Hongryul Lee, Suwon-si, Gyeonggi-do (KR); Jaehyuk Jang, Suwon-si, Gyeonggi-do (KR); Jeongsuong Yang, Suwon-si, Gyeonggi-do (KR); Byungchul Jang, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/276,784

(22) PCT Filed: Jul. 25, 2023
(86) PCT No.: PCT/KR2023/010724

§ 371 Date: Aug. 10, 2023

(30) Foreign Application Priority Data
Nov. 24, 2022 (KR) 10-2022-0159246
Feb. 13, 2023 (KR) 10-2023-0018668

(51) Int. Cl. H01M 8/12; H01M 8/1246

(52) U.S. Cl. CPC H01M 8/12; H01M 8/1246; H01M 2008/1293

(57) ABSTRACT

A porous solid oxide composite includes an electrode material and a solid oxide electrolyte material, and having mesopores arranged in an opal structure and micropores connecting the mesopores.

### TECHNICAL FIELD

This application claims priority to the benefit of Korean Patent Application No. 10-2022-0159246 filed in the Korean Intellectual Property Office on Nov, 24, 2022, and Korean Patent Application No. 10-2023-0018668 filed in the Korean Intellectual Property Office on Feb. 13, 2023, the entire contents of which are incorporated herein by reference.

The present disclosure relates to a porous solid oxide composite and a solid oxide cell including the same, wherein the porous solid oxide composite provides sufficient structural rigidity of the electrode layer, enabling a smooth gas supply to the electrode layer, and enabling the electrode layer to have an effective electrical conduction path. thereby providing a high area three-phase interface.

### BACKGROUND ART

A solid oxide fuel cell (SOFC) and a solid oxide electrolyzer cell (SOEC) generate electrical energy through an electrochemical reaction of a cell composed of an air electrode, a fuel electrode a solid oxide electrolyte having oxygen ion conductivity or electrolyze water and generate hydrogen through a reverse reaction of the solid oxide fuel cell. The cell has a configuration in which the air electrode and the fuel electrode are respectively disposed at both sided of the solid oxide electrolyte having oxygen ion conductivity, wherein air and hydrogen are respectively supplied to the air electrode and the fuel electrode through gas flow paths formed on a separator to have the electrochemical reaction to generate electricity or perform electrolysis.

The air electrode and the fuel electrode, where the reaction actually occurs, should be easily accessible for gas to make the reaction effective and have high electrical conductivity and ion conductivity. In particular, the air electrode and the fuel electrode should have an internal structure of well transferring ions and gas to the three-phase interface (the interface where the electrolyte, the electrodes, and the gas meet).

### DISCLOSURE OF INVENTION

### Technical Problem

One aspect of the present disclosure provides a porous solid oxide composite which provides sufficient structural rigidity of the electrode layer, enabling a smooth gas supply to the electrode layer, and enabling the electrode layer to have an effective electrical conduction path, thereby providing a high area three-phase interface.

### Solution to Problem

A porous solid oxide composite according to some embodiments of the present disclosure includes a composite of an electrode material and a solid oxide electrolyte material and has mesopores arranged in an opal structure such that each of the mesopores having a substantially spherical shape and substantially same size are regularly arranged and closely packed, and micropores connecting the mesopores.

The opal structure may have a structure that four to six of the mesopores arranged laterally to at least one of the mesopores, two to three of the mesopores placed directly on a top of at least one of the mesopores, and two to three of the mesopores placed directly under at least one of the mesopores.

At least one of the mesopores may be connected to adjacent one of the mesopores through at least one of the micropores, and each of the mesopores may be connected to at least three micropores.

An average pore size of the mesopores may be 0.3 μm to 20 μm.

Each of the mesopores may be substantially spherical shape, and an average diameter of each of the mesopores having spherical shape may be 0.3 μm to 20 μm.

Each of the micropores may have a tube-shape having a smaller average diameter than an average pore size of the mesopores. An average diameter of the tube-shape of the micropores may be 0.03 μm to 2 μm and an average length of the tube-shape of the micropores may be 0.05 μm to 3 μm.

The solid oxide electrolyte material may include an yttria-stabilized zirconia (YSZ), a scandia-stabilized zirconia (ScSZ), a gadolinia-doped ceria (GDC), a samaria-doped ceria (SDC), a strontium- and magnesium-doped lanthanum gallate (LSGM), a samaria- and ceria-doped barium zirconate (BaZrO₃), a samaria- and ceria-doped barium cerate (BaCeO₃), or a combination thereof.

The electrode material may be an air electrode material including a lanthanum-strontium manganese oxide (LSM), a lanthanum-strontium iron oxide (LSF), a lanthanum-strontium cobalt oxide (LSC), a lanthanum-strontium cobalt iron oxide (LSCF), a samarium-strontium cobalt oxide (SSC), a barium-strontium cobalt iron oxide (BSCF), a bismuth-ruthenium oxide, or a combination thereof.

The electrode material may be a fuel electrode material comprising nickel (Ni), cobalt (Co), ruthenium (Ru), palladium (Pd), platinum (Pt), an oxide thereof, or a combination thereof.

A weight ratio of the electrode material to the solid oxide electrolyte material may be 4:1 to 0.25:1.

A porosity of the porous solid oxide composite may be 30% to 50%.

A method of preparing a porous solid oxide composite according to some embodiments of the present disclosure includes: arranging pore formers in an opal structure on a substrate such that the pore formers in the opal structure corresponds to the mesopores of the porous solid oxide composite, wherein the opal structure is a structure that a plurality of spheres having substantially same size are regularly arranged and closely packed; forming connection portions between the pore formers wherein the shape of the connection portions are a tube-shape such that the connection portions correspond to the micropores of the porous solid oxide composite; reducing sizes of the pore formers; filling the spaces between the pore formers with an electrode material and a solid oxide electrolyte material; and removing the pore formers and connection portions by firing the electrode material and solid oxide electrolyte material by heat treatment.

The arranging of the pore formers in the opal structure may be performed by a Langmuir Blodgett (LB) method, a method using a template, a spin-coating method, a spraying method, or a method of forming a self-assembly after dipping.

The pore formers may include silica, carbon black, polystyrene (PS), poly(methyl methacrylate) (PMMA), polytetrafluoroethylene, starch, or a combination thereof.

The pore formers may have a structure having the same shape and arrangement as the ones of the mesopores.

The forming of the connection portions may be performed by heat treatment at 150° C. to 300° C. for 10 min to 30 min.

The reducing of the sizes of the pore formers may be performed using a chemical etching method or a plasma etching method.

The etching may be performed for 1 min to 10 min.

The heat treatment may be performed at 800° C. to 1500° C. for 1 hour to 5 hours.

A solid oxide cell according to some embodiments includes a solid oxide electrolyte. and air and fuel electrodes disposed on either side of the solid oxide electrolyte, respectively, wherein the air electrode, the fuel electrode, or both include a porous solid oxide composite including an electrode material and a solid oxide electrolyte material.

The porous solid oxide composite has mesopores arranged in an opal structure in which each of the mesopores has a substantially spherical shape and substantially same size, and the spheres are regularly arranged and closely packed, and micropores connecting the mesopores.

The solid oxide cell may be a solid oxide fuel cell (SOFC), a solid oxide electrolyzer cell (SOEC), or both.

### ADVANTAGEOUS EFFECTS OF INVENTION

According to some embodiments, the porous solid oxide composite provides sufficient structural rigidity of the electrode layer, enabling a smooth gas supply to the electrode layer, and enabling the electrode layer to have an effective electrical conduction path, thereby providing a high area three-phase interface.

### BRIEF DESCRIPTION OF DRAWINGS

The above and other aspects, features and other advantages of the present disclosure will be more clearly understood from the following detailed description taken in conjunction with the accompanying drawings.

FIG. 1 is a schematic cross-sectional view of a porous solid oxide composite, according to some embodiments of the present disclosure.

FIG. 2 is a schematic view of pore formers and the connection portions.

FIG. 3 is a transmission electron microscopy (TEM) photograph of pore formers and the connection portions.

FIG. 4 is a schematic view illustrating a solid oxide fuel cell according to some embodiments of the present disclosure.

FIG. 5 is a schematic view illustrating a solid oxide electrolyzer cell according to some embodiments of the present disclosure.

### MODE FOR THE INVENTION

Hereinafter, with reference to the accompanying drawings, the present embodiments will be described in detail so as to facilitate practice by one having ordinary skill in the art. The drawings and description are to be regarded as illustrative in nature and not restrictive. Like reference numerals designate like elements throughout the specification. Further, the accompanying drawings are provided only in order to allow embodiments disclosed in the present specification to be easily understood, and are not to be interpreted as limiting the spirit disclosed in the present specification, and it is to be understood that the present disclosure includes all modifications, equivalents, and substitutions without departing from the scope and spirit of the present disclosure. In addition, some components are exaggerated, omitted, or schematically depicted in the accompanying drawings, and the dimensions of each component are not necessarily indicative of actual dimensions.

In addition, unless explicitly described to the contrary, the word “comprise,” and variations such as “comprises” or “comprising,” will be understood to imply the inclusion of stated elements but not the exclusion of any other elements.

A porous solid oxide composite according to one aspect includes a composite of an electrode material and a solid oxide electrolyte material.

The solid oxide electrolyte material should have high oxygen ion conductivity and low electronic conductivity.

For example, the solid oxide electrolyte material may include an yttria-stabilized zirconia (YSZ), a scandia-stabilized zirconia (ScSZ), a gadolinia-doped ceria (GDC), a samaria-doped ceria (SDC), a strontium- and magnesium-doped lanthanum gallate (LSGM), a samaria- and ceria-doped barium zirconate (BaZrO₃), a samaria- and ceria-doped barium cerate (BaCeO₃), or a combination thereof.

The electrode material may include an air electrode material or a fuel electrode material.

The cathode material may include a material that reduces oxygen gas into oxygen ions.

For example, the air electrode material may include metal oxide particles having a perovskite-type crystal structure. The perovskite-type metal oxide may include a mixed ionic and electronic conductor (MIEC) material having both ionic and electronic conductivity, and has a high oxygen diffusion coefficient and a charge exchange reaction rate coefficient, allowing an oxygen reduction reaction to occur on the entire surface of the electrode, not just at the three-phase interface.

The perovskite-type metal oxide may be represented by Chemical Formula 1.

ABO_{3+γ} [Chemical Formula 1]

In Chemical Formula 1, A is an element including La, Ba, Sr, Sm, Gd, Ca, or a combination thereof, B is an element including Mn, Fe, Co, Ni, Cu, Ti, Nb, Cr, Sc, or a combination thereof, and γ indicates an oxygen excess or deficiency. The γ may be for example, in the range of 0≤γ≤0.3.

For example, the perovskite-type metal oxide may be represented by Chemical Formula 2.

A′₁₋ₓA″ₓB′O_{3±γ} [Chemical Formula 2]

In Chemical Formula 2, A′ is an element including Ba, La, Sm, or a combination thereof, A″ is an element including Sr, Ca, Ba, or a combination thereof and is different A′, B′ is an element including Mn, Fe, Co, Ni, Cu, Ti, Nb, Cr, Sc, or a combination thereof, 0≤x≤1, and γ indicates an oxygen excess or deficiency.

For example, the air electrode material may include a lanthanum-strontium manganese oxide (LSM), a lanthanum-strontium iron oxide (LSF), a lanthanum-strontium cobalt oxide (LSC), a lanthanum-strontium cobalt iron oxide (LSCF), a samarium-strontium cobalt oxide (SSC), a barium-strontium cobalt iron oxide (BSCF), a bismuth-ruthenium oxide, or a combination thereof.

In this case, if the solid oxide electrolyte material include an yttria-stabilized zirconia (YSZ) and the air electrode material include a lanthanum-strontium manganese oxide (LSM), the porous solid oxide composite may include an LSM-YSZ composite.

The fuel electrode material may electrochemically oxidize a fuel and transferring an electrical charge.

In some embodiments, the fuel electrode material may include a pure metal such as nickel (Ni), cobalt (Co), ruthenium (Ru), palladium (Pd), or platinum (Pt), or an oxide thereof.

In this case, the porous solid oxide composite may be a cermet, which is a combination of a fuel electrode material and a solid oxide electrolyte material. For example, when the solid oxide electrolyte material comprises an yttria-stabilized zirconia (YSZ) and the fuel electrode material comprises nickel (Ni), the porous solid oxide composite may include a Ni/YSZ cermet, or when the fuel electrode material includes ruthenium (Ru), the porous solid oxide composite may include a Ru/YSZ cermet.

A weight ratio of the electrode material to the solid oxide electrolyte material may be 4:1 to 0.25:1, for example 2:1 to 0.5:1. When the weight ratio of the electrode material to the solid oxide electrolyte material is less than 0.25, an electric communication path may not form.

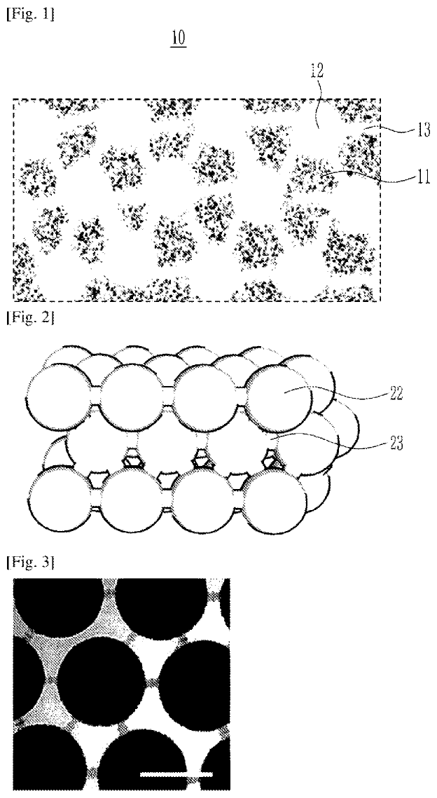

FIG. 1 is a schematic cross-sectional view of a porous solid oxide composite, according to some embodiments of the present disclosure.

Referring to FIG. 1, a porous solid oxide composite 10 has mesopores 12 arranged in an opal structure and micropores 13 connecting the mesopores 12.

In order for a solid oxide cell to well work, an electrode layer should be well supplied with external gas in a well-sealed state. Accordingly, the electrode layer has a porous structure to smoothly supply the gas to the three-phase interface thereinside. However, when the electrode layer has too high porosity, there may be problems of deteriorating durability due to weakened mechanical strength, hardly securing electrical conduction paths, and reducing an area of the three-phase interface. In order to control the porosity of the electrode layer, a pore former is added to a composition for the electrode layer, wherein closed pores tend to be formed. The closed pore has a shape such as a spherical without connecting adjacent pores. When the electrode layer has many closed pores, there may be problem of generating cracks due to an instant increase in internal pressure during volatilization of polymers and also, swelling or distortion, wherein the closed pores do not contribute to gas supply and thus deteriorate effectiveness of the electrode layer as the three-phase interface (gas reaction site).

The porous solid oxide composite according to some embodiments of the present disclosure has a three-dimensional pore network structure, in which the mesopores arranged in the opal structure are connected by the micropores, thereby securing excellent gas supply, electrical conduction, reaction sites, and structural rigidity.

The opal structure may have a structure in which four to six of the mesopores are arranged laterally to at least one of the mesopores, two to three of the mesopores are placed directly on a top of at least one of the mesopores, and two to three of the mesopores placed directly under at least one of the mesopores. For example, the opal structure may have a structure in which six other mesopores are located laterally to at least one mesopore of the mesopore, three other mesopores are located upward of the at least one mesopore, and three other mesopores are located downward of the at least one mesopore. In addition, the opal structure, such as a face centered cubic (FCC) lattice structure or a hexagonal close-packed (HCP) lattice structure, may have three mesopores on the top, six mesopores on the sides, and three mesopores on the bottom centered on at least one of the mesopores.

At least one mesopore of the mesopores may be connected to the adjacent mesopores through at least three or more, or for example, six to twelve micropores. When the mesopore is connected to the adjacent mesopores through one or two micropores, no open pores may be formed.

Each of the mesopores may have a substantially spherical (bead) shape, and the mesopores may be arranged at regular intervals and connected to the adjacent mesopores through the micropores. Herein, each of the micropores may have a tube-shape having a smaller average diameter than an average pore size of the mesopores.

An average pore size of the mesopores may be 0.3 μm to 20 μm, for example 1 μm to 10 μm.

An average diameter of the micropores may be 0.03 μm to 2 μm, for example 0.05 μm to 1 μm. When the micropores have an average diameter of less than 0.03 μm, there may be no smooth gas flow.

The average length of the micropores may be 0.05 μm to 3 μm, for example 0.05 μm to 2 μm.

A porosity of the porous solid oxide composite may be 30% to 50%, for example 35% to 45%. When the porosity of the porous solid oxide composite is less than 30%, the gas (fuel and air) required for the reaction may not be sufficiently supplied, and when the porosity is greater than 50%, water electrolysis cells may be easily damaged due to insufficient rigidity.

A method of preparing the porous solid oxide composite according to some embodiments of the present disclosure includes arranging pore formers in an opal structure on a substrate, forming connection portions between the pore formers, reducing sizes of the pore formers, filling the spaces between the pore formers with an electrode material and a solid oxide electrolyte material, and removing the pore formers and connection portions while firing the electrode material and solid oxide electrolyte material by heat treatment.

The pore formers may include, for example, silica, carbon black, polystyrene (PS), poly(methyl methacrylate) (PMMA), polytetrafluoroethylene, starch, or a combination thereof.

The arranging of the pore formers in the opal structure may be for example performed by a Langmuir Blodgett (LB) method, a method using a template, a spin-coating method, a spraying method, or a method of forming a self-assembly after dipping.

For example, after placing the pore formers in the opal structure, which has a shape of closed-packing the shares with a uniform size on a substrate, when the pore formers is heat treated, the pores in the spherical shape of the pore formers in the opal structure are connected to one another, forming the connection portions.

The heat treatment capable of forming the connection portions may be at 150° C. to 300° C. for 10 min to 30 min, for example 200° C. to 250° C. for 10 min to 20 min. A temperature and time of the heat treatment may be changed according to types and a size of materials. When the heat treatment temperature is less than 150° C., or the heat treatment time is less than 10 min, the connection (necking) may not be sufficiently formed, and when the heat-treatment temperature is greater than 300° C. or the heat-treatment time is greater than 30 min, pores among the pore formers may all be filled and changed into one film.

FIG. 2 is a schematic view of pore formers arranged in an opal structure with the connection portions and FIG. 3 is a transmission electron microscopy (TEM) photograph of pore formers arranged in an opal structure with the connection portions.

Referring to FIGS. 2 and 3, the spheres of the pore formers 22 are arranged at regular intervals, and each of the sphere of the pore formers 22 may be connected to adjacent spheres through at least three connection portions 23. Herein, the pore formers 22 have a structure that a plurality of spheres having substantially same size are regularly arranged and closely packed, wherein each of the connection portions 23 have a tube shape with a smaller average diameter than an average diameter of the sphere of the pore formers 22.

A size of the pore formers 22 connected by the connection portion 23 may be reduced. Due to the reduced size of the pore formers 22, the prepared porous solid oxide composite has porosity of greater than 70% and may not maintain structural rigidity.

The reducing of the sizes of the pore formers may be for example performed using a chemical etching method or a plasma etching method. For example, the etching may be performed for 1 min to 10 min.

The pore formers and the connection portions are removed by filling an electrode material and a solid oxide electrolyte material in a space of the pore formers and then firing the electrode material and the solid oxide electrolyte material through a heat treatment.

The descriptions of the electrode material and the solid oxide electrolyte material are the same as above, so repetition is omitted.

During the firing process, as the pore formers are removed at a low temperature, the electrode material and the solid oxide electrolyte material are densified and formed into a composite, forming mesopores in a region where the pore formers are present and also, forming micropores connecting the mesopores in another region where the connection portions are present.

The heat treatment for the firing may be performed at 800° C. to 1500° C. for 1 hour to 5 hours, for example 1250° C. to 1350° C. for 2 hours to 3 hours. When the heat-treatment temperature is less than 800° C. or the heat-treatment time is less than 1 hour, sufficient sintering may not be achieved, but when the heat-treatment temperature is greater than 1500° C., or the heat-treatment time is greater than 5 hours, the already-generated pores may disappear again.

A solid oxide cell according to another aspect includes a solid oxide electrolyte, and air and fuel electrodes disposed on either side of the solid oxide electrolyte, respectively.

For example, the solid oxide cell may be a solid oxide fuel cell (SOFC), a solid oxide electrolyzer cell (SOEC), or both.

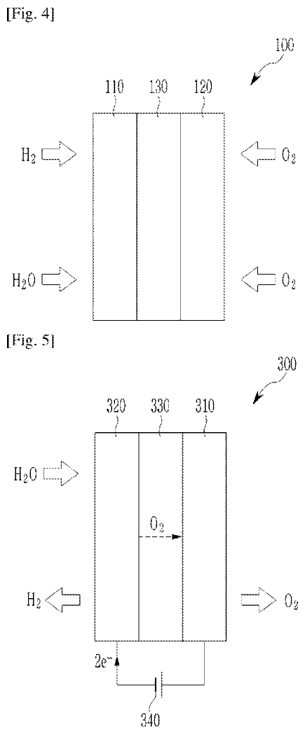

FIG. 4 is a schematic view showing a case that the solid oxide cell is a solid oxide fuel cell.

Referring to FIG. 4, the solid oxide fuel cell 100 includes a fuel electrode 110, an air electrode 120 disposed facing the fuel electrode 110, and an oxygen ion conductive solid oxide electrolyte 130 disposed between the fuel electrode 110 and the air electrode 120.

The solid oxide fuel cell 100 has an electrochemical reaction as shown in Reaction Scheme 1, which exhibits an air electrode reaction in which oxygen gas (O₂) of the air electrode 120 is changed into oxygen ions (O₂) and a fuel electrode reaction in which a fuel (H₂ or hydrocarbon) of the fuel electrode 110 reacts with the oxygen ions moved through and the electrolyte.

### Reaction Scheme 1

Air electrode reaction: ½O₂+2e⁻→O₂⁻

Fuel electrode reaction: H₂+O₂⁻→H₂O+2e⁻

In the air electrode 120 of the solid oxide fuel cell 100, the oxygen adsorbed into the electrode surface is dissociated and moves through surface diffusion to the three-phase interface (triple phase boundary) where the solid oxide electrolyte 130, the air electrode 120, and pores (not shown) meet to gain electrons into oxygen ions, and the produced oxygen ions move toward the fuel electrode 110 through the solid oxide electrolyte 130.

In the fuel electrode 110 of the solid oxide fuel cell 100, the moved oxygen ions are combined with hydrogen in the fuel to produce water. At this time, the hydrogen emits the electrons to be hydrogen ions (H⁺) which combine with the oxygen ions. The discharged electrons move toward the air electrode 120 through a wire (not shown) to change the oxygen into the oxygen ions. Through this electron movement, the solid oxide fuel cell 100 may perform a battery function.

FIG. 5 is a schematic view illustrating a case where the solid oxide cell is a solid oxide electrolyzer cell.

Referring to FIG. 5, a solid oxide electrolyzer cell 300 includes an air electrode 310, a fuel electrode 320 disposed facing the air electrode 310, and an oxygen ion conductive solid oxide electrolyte 330 disposed between the air electrode 310 and the fuel electrode 320.

The solid oxide electrolyzer cell 300 has an electrochemical reaction shown in Reaction Scheme 2, which exhibits a fuel electrode reaction where water (H₂O) of the fuel electrode 320 is changed into hydrogen gas (H₂) and oxygen ions (O₂⁻) and an air electrode reaction wherein the oxygen ions moved through the solid oxide electrolyte 330 are changed into oxygen gas (O₂). This reaction is contrary to reaction principles of a conventional fuel cell.

### Reaction Scheme 2

Fuel electrode reaction: H₂O+2e⁻→O₂+H₂

Air electrode reaction: O₂⁻→½O₂+2e⁻

When electric power is applied to the solid oxide electrolyzer cell 300 from an external power source 340, the solid oxide electrolyzer cell 300 is supplied with electrons from the external power source 340. The electrons react with water supplied to the fuel electrode 320 to generate the hydrogen gas and the oxygen ions. The hydrogen gas is discharged to the outside, and the oxygen ions pass through the electrolyte 330 to the air electrode 310. The oxygen ions moved to the air electrode 310 lose electrons and then, are changed into oxygen gas and discharged to the outside. The electrons flow to the external power source 340. Through this electron movement, the solid oxide electrolyzer cell 300 may electrolyze the water to form the hydrogen gas at the fuel electrode 320 and form the oxygen gas at the air electrode 310.

Herein, the air electrodes 120 and 310, the fuel electrodes 110 and 320, or both of them include the porous solid oxide composite according to one aspect. This is the same as described above and will not be repeatedly illustrated again.

The air electrodes 120 and 310 may, for example, have a thickness of 1 μm to 100 μm or 5 μm to 50 μm.

The fuel electrodes 110 and 320 may, for example, have a thickness of 1 μm to 1000 μm or 5 μm to 100 μm.

The solid oxide electrolytes 130 and 330 play a role of transporting the oxygen ions generated from the air electrodes 120 and 310 to the fuel electrodes 110 and 320 through ion conduction. The solid oxide electrolytes 130 and 330 have gas impermeability to block a contact between air and the fuel electrodes 110 and 320 and also block the electrons generated at the fuel electrodes 110 and 320 from directly moving toward the air electrodes due to high oxygen ion conductivity and low electron conductivity (high electrical resistance, high insulation).

In addition, since the solid oxide electrolytes 130 and 330 have the air electrodes 120 and 310 and the fuel electrodes 110 and 320, which have a very large oxygen partial pressure difference, on both sides thereof, the aforementioned properties may be necessary to maintain in a wide oxygen partial pressure region.

The materials of these solid oxide electrolytes 130 and 330 are not particularly limited as long as they are generally available in the art, and may include, for example, an yttria-stabilized zirconia (YSZ), a scandia-stabilized zirconia (ScSZ), a gadolinia-doped ceria (GDC), a samaria-doped ceria (SDC), a strontium- and magnesium-doped lanthanum gallate (LSGM), a samaria- and ceria-doped barium zirconate (BaZrO₃), a samaria- and ceria-doped barium cerate (BaCeO₃), or a combination thereof.

The solid oxide electrolytes 130 and 330 may, for example, have a thickness of 10 μm to 100 μm or 100 μm to 50 μm.

Optionally, the solid oxide cells 100 and 300 may further include an electrical collecting layer (not shown) including an electrical conductor on at least one side of the air electrodes 120 and 310, for example an outer side of the air electrodes 120 and 310. The electrical collecting layer may act as a current collector to collect electricity in a configuration of the air electrode.

The electrical collecting layer may include, for example, a lanthanum cobalt oxide (LaCoO₃), a lanthanum strontium cobalt oxide (LSC), a lanthanum strontium cobalt iron oxide (LSCF), a lanthanum strontium cobalt manganese oxide (LSCM), a lanthanum strontium manganese oxide (LSM), a lanthanum strontium iron oxide (LSF), or a combination thereof. The electrical collecting layer may use the above-listed materials alone or in a combination of two or more, wherein these materials may be formed into a single layer or two or more layers with a stacked structure.

The solid oxide cells 100 and 300 may be manufactured in conventional methods known in various literature in the art.

The solid oxide cells 100 and 300 may be applied to various structures such as a cylindrical (tubular) stack, a flat tubular stack, a planar-type stack, and the like.

In addition, the solid oxide cells 100 and 300 may be in the form of a stack of unit cells. For example, the unit cells (Membrane and Electrode Assembly (MEA)) composed of the air electrodes 120 and 310, the fuel electrodes 110 and 320, and the solid oxide electrolytes 130 and 330 are stacked in series, and separators electrically connected between the unit cells are disposed, obtaining the stack of the unit cells.

While this disclosure has been described in connection with what is presently considered to be practical example embodiments, it is to be understood that the present disclosure is not limited to the disclosed embodiments. On the contrary, it is intended to cover various modifications and equivalent arrangements included within the spirit and scope of the appended claims.

### DESCRIPTION OF SYMBOLS

10: porous solid oxide composite
11: composite of electrode material and solid oxide electrolyte material
12: mesopore
13: micropore
22: pore former
23: connection portion
100: solid oxide fuel cell
110: fuel electrode
120: air electrode
130: solid oxide electrolyte
300: solid oxide electrolyzer cell
310: air electrode
320: fuel electrode
330: solid oxide electrolyte
340: external power

### INDUSTRIAL APPLICABILITY

The present disclosure relates to a porous solid oxide composite and a solid oxide cell including the same, wherein the porous solid oxide composite provides sufficient structural rigidity of the electrode layer, enabling a smooth gas supply to the electrode layer, and enabling the electrode layer to have an effective electrical conduction path, thereby providing a high area three-phase interface.

1. A porous solid oxide composite, comprising an electrode material and a solid oxide electrolyte material, wherein the porous solid oxide composite has mesopores arranged in an opal structure and micropores connecting the mesopores.

2. The porous solid oxide composite of claim 1, wherein the opal structure has a structure that four to six of the mesopores arranged laterally next to at least one of the mesopores, two to three of the mesopores placed directly on a top of at least one of the mesopores, and two to three of the mesopores placed directly under at least one of the mesopores.

3. The porous solid oxide composite of claim 1, wherein at least one of the mesopores is connected to at least three of the micropores.

4. The porous solid oxide composite of claim 1, wherein an average pore size of the mesopores is 0.3 μm to 20 μm.

5. The porous solid oxide composite of claim 1, wherein each of the mesopores has a spherical shape.

6. The porous solid oxide composite of claim 5, wherein an average diameter of each of the micropores in the spherical shape is 0.03 μm to 2 μm.

7. The porous solid oxide composite of claim 1, wherein each of the micropores has a tube shape having a smaller average diameter than an average pore size of the mesopores.

8. The porous solid oxide composite of claim 7, wherein an average length of the micropores in the tube shape is 0.05 μm to 3 μm.

9. The porous solid oxide composite of claim 1, wherein a weight ratio of the electrode material to the solid oxide electrolyte material is 4:1 to 0.25:1.

10. The porous solid oxide composite of claim 1, wherein the porous solid oxide composite has a porosity of 30% to 50%.

11. The porous solid oxide composite of claim 1, wherein
the solid oxide electrolyte material includes an yttria-stabilized zirconia (YSZ), a scandia-stabilized zirconia (ScSZ), a gadolinia-doped ceria (GDC), a samaria-doped ceria (SDC), a strontium- and magnesium-doped lanthanum gallate (LSGM), a samaria- and ceria-doped barium zirconate (BaZrO₃), a samaria- and ceria-doped barium cerate (BaCeO₃), or a combination thereof.

12. The porous solid oxide composite of claim 1, wherein
the electrode material comprises an air electrode material including a lanthanum-strontium manganese oxide (LSM), a lanthanum-strontium iron oxide (LSF), a lanthanum-strontium cobalt oxide (LSC), a lanthanum-strontium cobalt iron oxide (LSCF), a samarium-strontium cobalt oxide (SSC), a barium-strontium cobalt iron oxide (BSCF), a bismuth-ruthenium oxide, or a combination thereof.

13. The porous solid oxide composite of claim 1, wherein
the electrode material is a fuel electrode material comprising nickel (Ni), cobalt (Co), ruthenium (Ru), palladium (Pd), platinum (Pt), an oxide thereof, or a combination thereof.

14. A method of preparing a porous solid oxide composite, comprising
arranging pore formers in an opal structure on a substrate,
forming connection portions between the pore formers,
reducing sizes of the pore formers,
filling spaces between the pore formers with an electrode material and a solid oxide electrolyte material, and
removing the pore formers and the connection portions by firing the electrode material and solid oxide electrolyte material by heat treatment.

15. The method of claim 14, wherein
the arranging of the pore formers in the opal structure is performed by a Langmuir Blodgett (LB) method, a method using a template, a spin-coating method, a spraying method, or a method of forming a self-assembly after dipping.

16. The method of claim 14, wherein
the pore formers includes silica, carbon black, polystyrene (PS), poly (methyl methacrylate) (PMMA), polytetrafluoroethylene, starch, or a combination thereof.

17. The method of claim 14, wherein
the forming the connection portions comprises a heat treatment at 150° C. to 300° C. for 10 min to 30 min.

18. The method of claim 14, wherein
the reducing of the sizes of the pore formers is performed by using a chemical etching or a plasma etching.

19. The method of claim 14, wherein
the heat treatment is performed at 800° C. to 1500° C. for 1 hour to 5 hours.

20. A solid oxide cell, comprising
a solid oxide electrolyte,
an air electrode disposed on one side of the solid oxide electrolyte, and a fuel electrode disposed on an opposite side of the solid oxide electrode,
wherein at least one of the air electrode or the fuel electrode includes a porous solid oxide composite including an electrode material and a solid oxide electrolyte material, and
the porous solid oxide composite has mesopores arranged in an opal structure and micropores connecting the mesopores.

21. The solid oxide cell of claim 20, wherein
the solid oxide cell is a solid oxide fuel cell (SOFC), a solid oxide electrolyzer cell (SOEC), or both.
